(19) United States
(12) Patent Application Publication
(10) Pub. No.: US 2002/0041694 A1
(43) Pub. Date: Apr. 11, 2002

(54) Transducer

(75) Inventor: Hugo Remi Michiels, Moerbeke-Waas (BE)

Correspondence Address: BACON & THOMAS, PLLC, 625 SLATERS LANE, FOURTH FLOOR, ALEXANDRIA, VA, 22314

(73) Assignee: Sonitron, naamloze vennootschap, Moerbeke-waas (BE)

(21) Appl. No.: 09/901,635

(22) Filed: Jul. 11, 2001

(30) Foreign Application Priority Data
Jul. 11, 2000 (BE) 2000/0439

(51) Int. Cl. H04R 25/00; H04R 1/00

(52) U.S. Cl. 381/190; 381/173; 381/423

(57) ABSTRACT

Transducer, consisting of a one-piece or multi-piece piezoceramic disk (2) and a membrane (3), characterized in that the membrane (3) is realized in a material which attenuates sound vibrations.

### BACKGROUND OF THE INVENTION 1. Field of the Invention

The present invention relates to a transducer or, in other words, to an element for sound-reproduction and/or recording, more particularly a loudspeaker or microphone.

2. Discussion of the Related Art

For simplicity's sake, in the description following hereafter it will only be spoken about transducers for reproducing sound, in other words, sound-reproducing devices, however, such transducers relate to reproducing as well as recording devices.

Still more particularly, the invention relates to piezoelectric reproducers, of the type using a vibration membrane which is composed of a carrier and a piezoceramic disk attached upon this carrier.

In the Belgian patent No. 09700309, improvements to the aforementioned type of transducers are described which consist in that a wall is provided which is situated at a small distance to the vibration membrane, such that an attenuating effect on the sound vibrations generated by the vibration membrane is obtained.

In the Belgian patent No. 09700934, also improvements to the aforementioned type of transducers are described, which substantially consist in that the vibration membrane is provided with an attenuating layer which comprises metal particles.

With the thus known piezoelectric reproducing elements, the carrier of the membrane always consists of a metal disk.

### SUMMARY OF THE INVENTION

Although the reproducing elements, as described in the aforementioned patents, deliver very good results, the applicant of the present patent has found out that, by replacing the aforementioned metal membrane by a membrane made of a sound-attenuating material, such as synthetic material, a polymer or such, considerably better results are obtained.

### BRIEF DESCRIPTION OF THE DRAWINGS

With the intention of better showing the characteristics of the invention, hereafter several embodiments of the element according to the invention are described, with reference to the accompanying drawings, wherein:

FIG. 1 represents the vibration modes in square metal membranes;

FIG. 2 represents the vibration modes in rectangular metal membranes;

FIG. 3 represents the vibration modes in circular metal membranes;

FIG. 4 represents a diagram of the course of the frequency reproduction of known piezo-reproducers with metal membrane;

FIG. 5 represents the diagram of the course of the frequency spectrum measurement of a sinus of 1 kHz on an electro-dynamic loudspeaker;

FIG. 6 represents a diagram similar to that of FIG. 5, however, for a piezoceramic disk on a metal membrane;

FIG. 7 represents a schematic representation of a transducer according to the invention;

FIG. 8 represents the electric diagram of a piezo-disk under load;

FIG. 9 represents the electric diagram of a piezo-disk glued onto a plate of synthetic material;

FIGS. 10 and 11 represent schematic embodiments of reproducing elements according to the invention;

FIGS. 12 and 13 represent the function course of transducers according to FIGS. 10 and 11;

FIGS. 14 to 19 represent different forms of transducers;

FIG. 20 represents the diagram of the harmonic contents of 1 kHz of a transducer according to the invention;

FIG. 21 represents the frequency characteristic of a transducer according to the invention;

FIG. 22 represents a cross-section of a suspension possibility of a transducer according to the invention;

FIG. 23, at a larger scale, represents the portion indicated by F23 in FIG. 22;

FIG. 24 represents a view according to arrow F24 in FIG. 23;

FIGS. 25 and 26 represent electric diagrams of attenuations in the membrane of a transducer according to the invention;

FIG. 27 is a view similar to that of FIG. 23;

FIG. 28, at a larger scale, represents the part indicated by F28 in FIG. 27;

FIG. 29 represents a cross-section of a transducer according to the invention in combination with a front plate;

FIG. 30 represents a view according to arrow F30 in FIG. 29;

FIG. 31 represents the electric diagram of the frequency-filtering function of the front plate according to FIG. 29;

FIG. 32 represents a transducer with a two-part ceramic disk;

FIG. 33 represents a cross-section of a particular embodiment of a transducer according to the invention;

FIG. 34, at a larger scale, represents the part indicated by F34 in FIG. 33;

FIG. 35 represents a top view of another possible form of embodiment of a transducer according to the invention;

FIG. 36 represents a cross-section according to line XXXVI-XXXVI in FIG. 35;

FIG. 37 represents a diagram of the frequency characteristics of a transducer according to FIG. 35;

FIG. 38 represents a variant of FIG. 22;

FIG. 39 represents a diagram similar to that of FIG. 37, however, for a transducer with a cylindrical polymer membrane and a cylindrical ceramic disk;

FIG. 40 represents the frequency characteristic for a transducer, as intended in FIG. 32;

FIGS. 41 and 42 represent cross-sections of transducers according to the invention which are provided in a particular or an existing housing, for example, the housing of a cellular phone;

FIG. 43 represents a transducer according to the invention, formed by a cellular phone-housing which functions as a membrane, and a piezoceramic disk provided therein.

FIG. 44 represents another variant of a transducer according to the invention.

### DESCRIPTION OF PREFERRED EMBODIMENTS

In the aforementioned Belgian patent No. 09700309, it is indicated that the combination of a piezoceramic disk with a metal membrane which is attached at its circumferential line by means of a flexible glue, may exert a strong influence upon the lowermost frequency of resonance.

Indeed, as is known, the frequency of resonance of a transducer which is composed of, for example, a piezoceramic disk which is glued onto a brass membrane, is determined by:

$${f}_{r} = \frac{t}{S} \sqrt{\frac{y}{d ( 1 - {r}^{2} )}}$$

wherein:

t=thickness of the membrane

S=surface of the membrane

y=Young modulus

r=Poisson ratio.

When suspending such membrane at the edge, this formula becomes:

$${f}_{r} = K \cdot \frac{t}{S} \sqrt{\frac{y}{d ( 1 - {r}^{2} )}}$$

wherein K is an assembly factor.

The edge width of the suspension and the viscosity of the glue are factors exerting an influence onto the frequency of resonance.

The formula of the frequency of resonance then becomes:

$${f}_{r} = \frac{b \cdot v \cdot t}{{D}_{4} \cdot S} \sqrt{\frac{y}{d ( 1 - {r}^{2} )}} \cdot \frac{1}{G}$$

wherein:

$$\frac{1}{G} = 1$$

b=width of supporting edge for glue

D₄=diameter of the membrane which is not supported

V=viscosity of the glue.

The distance between the membrane and the surface of the front wall increases the apparent weight of the membrane.

The frequency of resonance then becomes:

$${f}_{r} = \frac{b \cdot v \cdot t}{{D}_{4} \cdot S} \sqrt{\frac{y}{d ( {S}_{1} / {D}_{1} ) ( 1 - {r}^{2} )}} \cdot \frac{1}{G}$$

wherein:

$$\frac{1}{G} = 1$$

S₁=surface of free-moving part

D₁=distance between moving part of membrane and wall

Due to this suspension and construction, frequencies can be reproduced starting from 100 Hz up to 20 kHz.

In order to attenuate the resonance peaks which occur in the metal membrane, in the Belgian patent No. 09700934 a solution was presented which consists in that a layer of flexible glue, such as, for example, silicones or elastomers filled with metal powder, can be provided on the membrane, which can lower the frequency of resonance and, at the same time, attenuate the peaks of the frequency of resonance and move them to another frequency.

The patents mentioned in the aforegoing describe a piezoceramic loudspeaker consisting of the composition of a piezoceramic disk, glued onto a metal membrane, for example, made of brass.

The drawbacks of this combination are that the frequency reproduction is not flat and that a strong harmonic distortion is created which depends on the frequency contents, such that the reproduction quality for music and speech is insufficient.

In order to prevent these drawbacks, the present invention relates to a piezoelectric reproduction element, whereby the piezoceramic disk is glued onto a membrane which consists of a relatively flexible material, more particularly a material which attenuates sound vibrations, for example, a synthetic material, still more particularly a polymer.

Preferably, the aforementioned disk is glued onto the membrane by means of a hard glue, whereas the whole unit can be glued at its circumferential edge into a suitable frame, for example, made of synthetic material.

This construction has a flat frequency characteristic, the quality of which is more than sufficient for reproducing music as well as speech for industrial applications with a low harmonic distortion of an average 3% between 100 Hz and 20 kHz.

The theoretical explanation following hereafter explains this improvement.

The membrane made of metal has a natural resonance which will fragment into different vibration zones according to the vibration frequency which is supplied, to wit the so-called vibration modes.

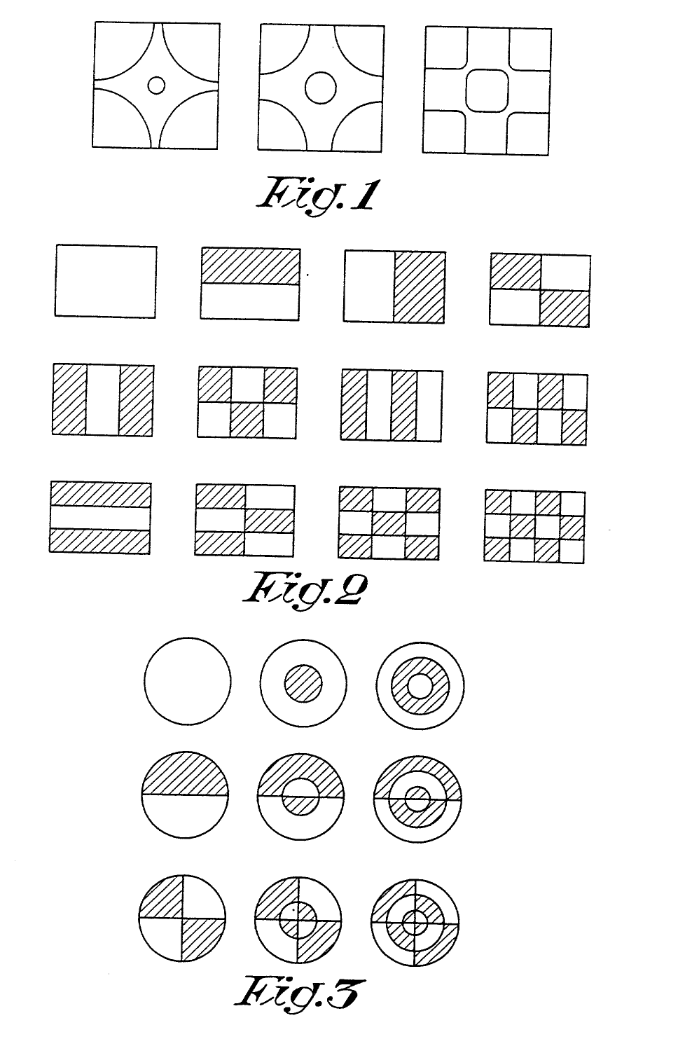

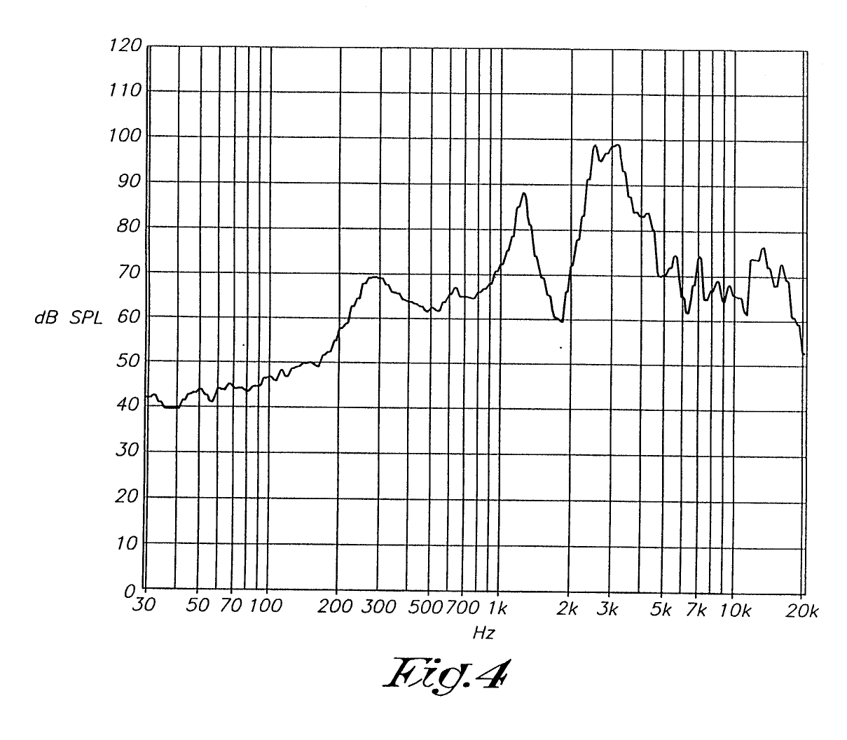

The vibration modes in a square, rectangular or circular membrane, according to FIGS. 1, 2 and 3, respectively, are a multiple or harmonic of the base frequency.

When a piezoceramic disk is glued onto such membrane, new vibration modes are created. Apart from the fundamental frequency of resonance-sound pressure, the acoustic reproduction of such construction further has a number of resonances which depend on the vibration modes of the transducer which is composed of a metal membrane and a piezoceramic disk. The frequency reproduction of a piezo-loudspeaker constructed with such transducer therefore yields a selective frequency reproduction, such as represented in FIG. 4.

In this figure, one will observe clearly stronger reproductions at 300 Hz, 1500 Hz, 2500 Hz, 3000 Hz, 5600 Hz, 7000 Hz, 8500 Hz, 9000 Hz and 15 kHz, whereby 300 Hz is the self-resonance of the whole system, thus, of the mounted transducer in a housing. The other frequency peaks either are harmonics of the system's frequency of resonance or the sum of the harmonic with the vibration modes of the transducer. The frequency minimums are the sum of the anti-resonance points of the transducer and harmonics at those frequency points.

When a frequency-spectrum measurement is performed of a sinus of 1 kHz on an electrodynamic loudspeaker, the reproduction of the base wave on 1 Khz and its higher harmonics at 2 kHz, 3 kHz, 6 kHz, 7 kHz, as represented in FIG. 5, are obtained.

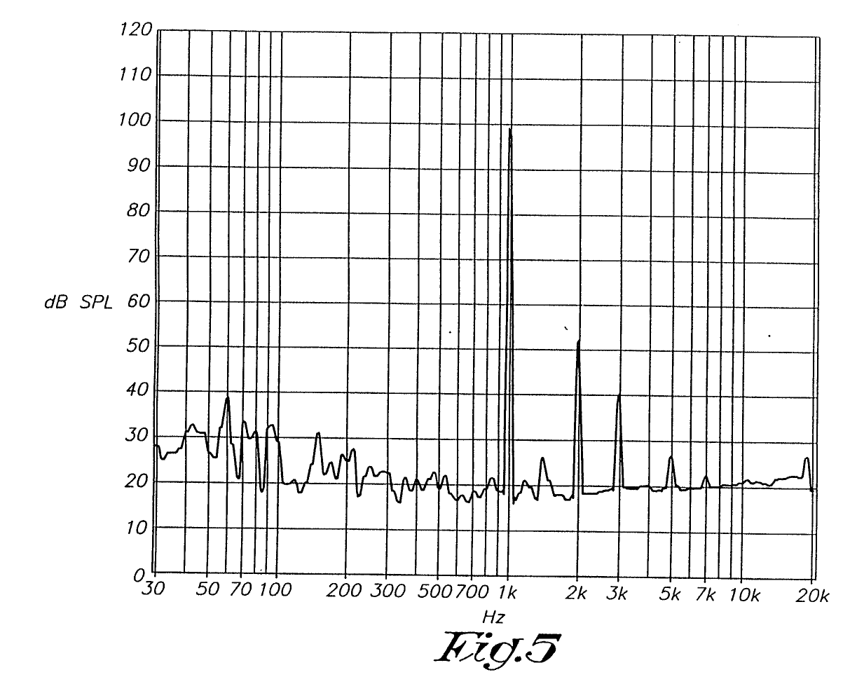

When the same measurement is performed at a piezoceramic disk which is provided on a metal membrane, a frequency spectrum reproduction of the supplied base frequency of 1 kHz is obtained, and higher harmonics of 2 kHz, 3 kHz, 4 kHz, 5 kHz, but moreover one obtains reproductions of lower harmonics of 500 Hz, 250 Hz, and apart therefrom also reproductions of complex resonance vibrations of modes originating from the transducer, for example, 1300 Hz, 1600 Hz, 2500 Hz, 3500 Hz, such as becomes clear from FIG. 6.

A piezoceramic disk glued onto a metal membrane therefore vibrates with a variable amplitude in function of the frequency. A loudspeaker must reproduce all frequencies with one and the same sound pressure. In order to obtain this, the effect of the harmonics must be eliminated with the vibration modes, which is realized by drastically lowering the natural resonant frequency of the vibration system, such that the higher harmonics have a much smaller amplitude in the audible range.

The formula of the frequency of resonance is:

$${f}_{r} = \frac{t}{S} \sqrt{\frac{y}{d ( 1 - {r}^{2} )}}$$

in which fᵣ can be lowered by using a material for the membrane with a low modulus of y (Young).

Modulus of y in Mpa:

| | |
|---|---|
| brass | 62.000 |
| nickel | 200.000 |
| nylon | 2.700 |
| elastomere | 5.000 |

Ratio of Poisson:

| | |
|---|---|
| brass | 0,36 |
| nylon | 0,38 |
| Density d in kg/m³: | |
| brass | 8,5 |
| nickel | 8,9 |
| nylon | 0,9 |
| elastomer | 0,95 |

The part

$$\frac{y}{d ( 1 - {r}^{2} )}$$

when using polymers becomes 3 to 4 times smaller. A frequency of resonance of 200 Hz therefore drops towards +/−60 Hz.

As is known, no self-resonances can occur in plates when a sufficient elastic resistance is present. In FIG. 7, a transducer 1 according to the invention is represented which consists of a piezoceramic disk 2, glued onto a plate 3 of synthetic material, for example, a polymer, in other words, a transformer of alternating current to sound waves. In this figure, the air vibrations are represented by 4.

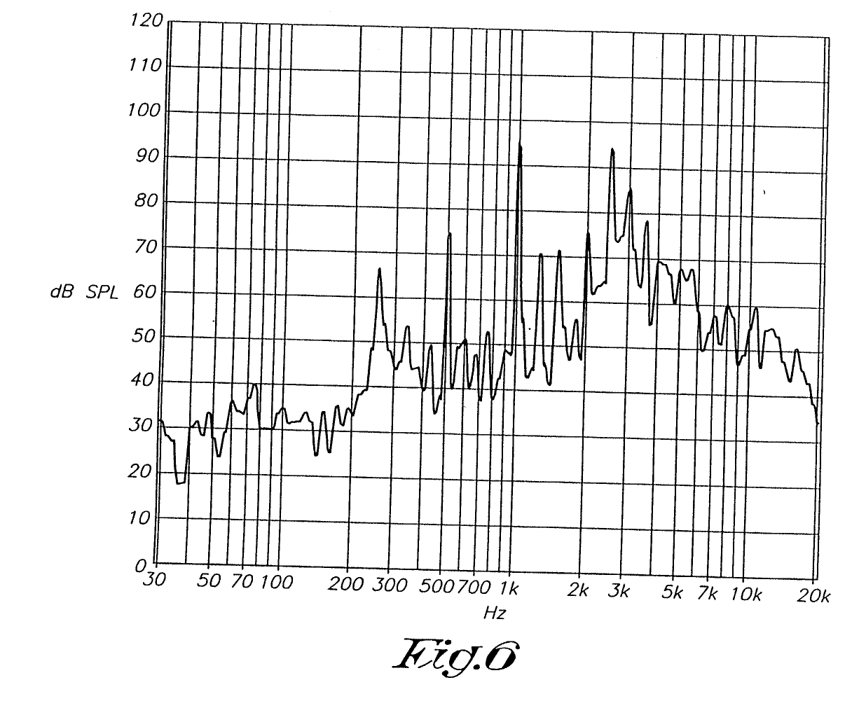

The equivalent electric diagram of a piezo-disk under load is represented in FIG. 8, in which the indicated elements have the following signification.

CO=capacitance of the loaded transducer

RO=the dielectric loss of the transducer

[2 Π (C0+C1) tan δ]⁻¹

R1=mechanical loss in the transducer

C1=rigidity of the piezo-material

L1=the mass of the piezo-material.

FIG. 9 represents an equivalent electric scheme of a piezo-disk glued onto a polymer plate, whereby the indicated elements, apart from those according to FIG. 8, have the following signification.

C2=rigidity of the polymer plate

L2=mass of the polymer plate

R2=mechanical losses in the glue layer and in the polymer plate.

Resonances can not occur when the circuit is not tuned to the frequencies fulfilling the condition of resonance. The parallel load of the polymer plate, whether in rigidity or mass, and the solid attachment to the piezo-disk prevent the condition of resonance.

C2=y2 of polymer is 10³ MPa

C1=y1 of ceramics is 10⁵ MPa.

In order to obtain a parallel resonance (Frp) condition, Frp=L1+L2 and CO must fulfill the following condition:

$$Frp = \frac{1}{\sqrt{2 π ( L1 + L2 ) CO}}$$

Frp is highly resistive.

In order to obtain a serial-resonance Frs condition,

Frs=L1 and C1+C2 must fulfill the following condition:

$$Frs = \frac{1}{\sqrt{2 π L1 ( C1 + C2 )}}$$

Frs is low resistive.

The influence of the polymer plate is very high with resonance conditions:

R1 and R2 is the serial impedance which determines the quality of the circuit in resonance and which will prevent the occurrence of selective resonance conditions.

C1 and C2 is the rigidity of the system. The influence on the rigidity by the polymer plate is very high:

C1=y of ceramics=300.000 MPa

C2=y of polymer=2.700 MPa.

L1 and L2 is the overall mass of the system, whereby the mass of:

L1=3 Kgr/mⁿ ceramics and the mass of

L2=0,9 Kgr/mⁿ polymer.

Thus, the load on the polymer plate and the influence thereupon is very high in order to have self-resonances occur for certain frequencies. Thus, no resonances occur due to harmonics or complex frequency signals.

The support or suspension of the vibration system has to fulfill certain conditions.

1) The vibrations must be sufficiently attenuated in the suspension and not be refracted in the plate.

2) The suspension must be sufficiently rigid in order to keep the plate flat during bending.

3) The functional course of the difference of the distance between the circumference of the polymer membrane and the piezoceramic disk from the center of the polymer membrane must be positive or negative, and the course either has to be increasing or decreasing and not continuous, over an angle of at least 90°.

Therefore, the covered distance between the edge of the membrane and the ceramic material is not constant, and no standing waves will occur which would show a concentrical nodal pattern, and therefore resonances are eliminated.

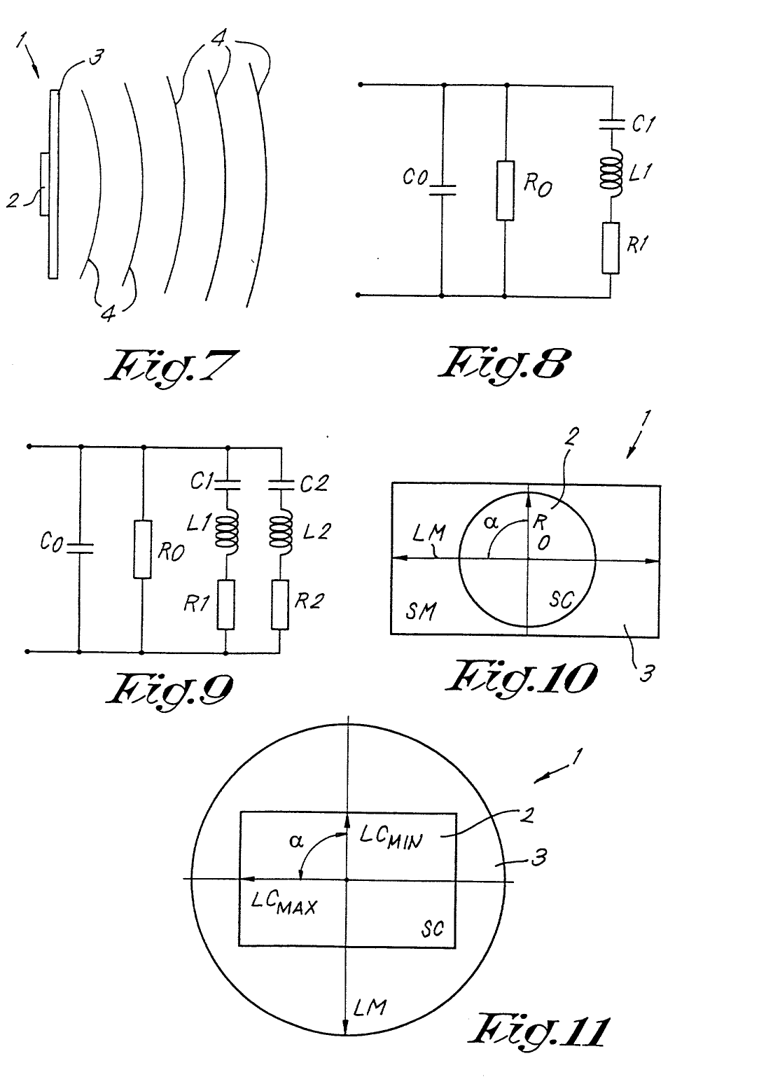

In FIGS. 10 and 11, two embodiments of transducers 1 according to the invention are represented, which transducers consist of a piezoceramic disk 2 and a membrane 3 made of synthetic material.

In these figures is:

LM=length of the membrane of synthetic material

R=radius of the ceramic disk

α=90°

SC=surface of the ceramic disk

SM=surface of the membrane.

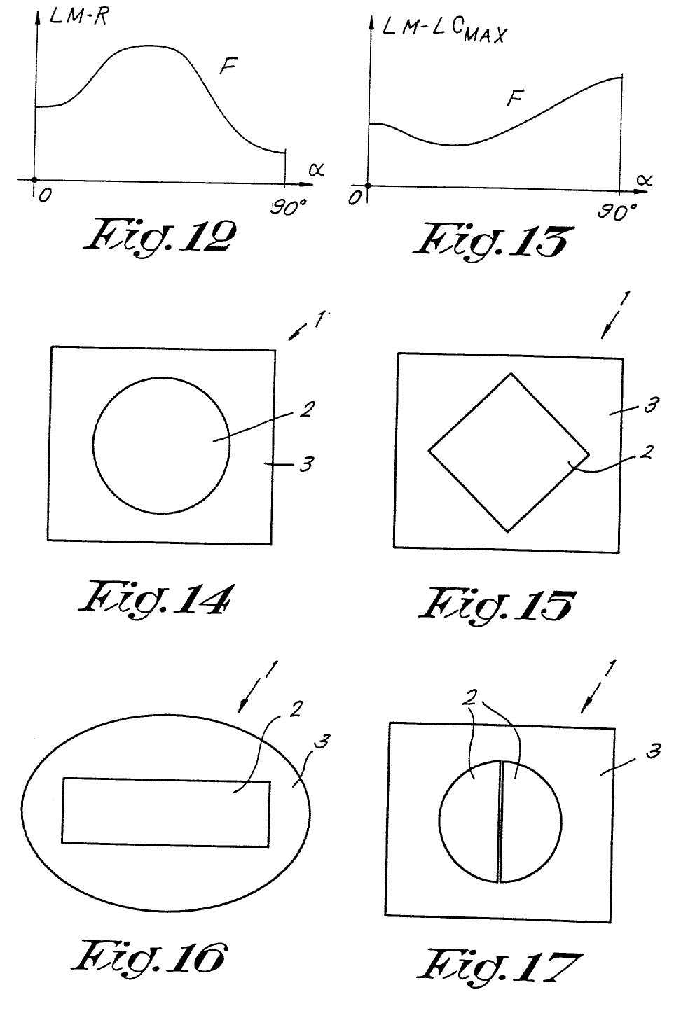

The functional course of a transducer 1 according to FIG. 10 is represented in FIG. 12, whereas that of the transducer 1 according to FIG. 11 is represented in FIG. 13, and whereby, if LM>R, then the function F is (LM-R) over α=90°.

The function is increasing and decreasing, positive and discontinuous.

In the case of FIG. 11, LM>LC max.

In FIGS. 14 to 19, several forms of embodiments of transducers 1 according to the invention are represented, whereby in FIGS. 17, 18 and 19 the ceramic disk is composed of several parts which are glued closely together onto their carrier made of synthetic material and which are connected to each other electrically.

As becomes clear from these figures, the ceramic disks may have any shape.

As already discussed in the aforegoing, in FIG. 6 the harmonic contents of a transducer according to the aforementioned Belgian patent applications No. 09700309 and No. 09700934 is represented. The same signal of 1 kHz is represented in FIG. 20 by a combination of a piezoceramic disk on a polymer plate, in which figure the pure reproduction of 1 kHz is clearly visible, with its natural harmonics of 2 kHz, 3 kHz, 4 kHz, 5 kHz, 6 kHz and 7 kHz. Other peaks are not present or negligible.

A frequency characteristic measured with a pink noise generator of the same ceramics/polymer construction is represented in FIG. 21. A comparison with an electro-dynamic transducer with approximately the same surface area and the same harmonic reproduction of 1 kHz is represented in FIG. 5.

The harmonic contents of 1 kHz sinus represented by an electro-dynamic transducer and a combination of piezoceramics glued onto a polymer therefore is the same and equally pure.

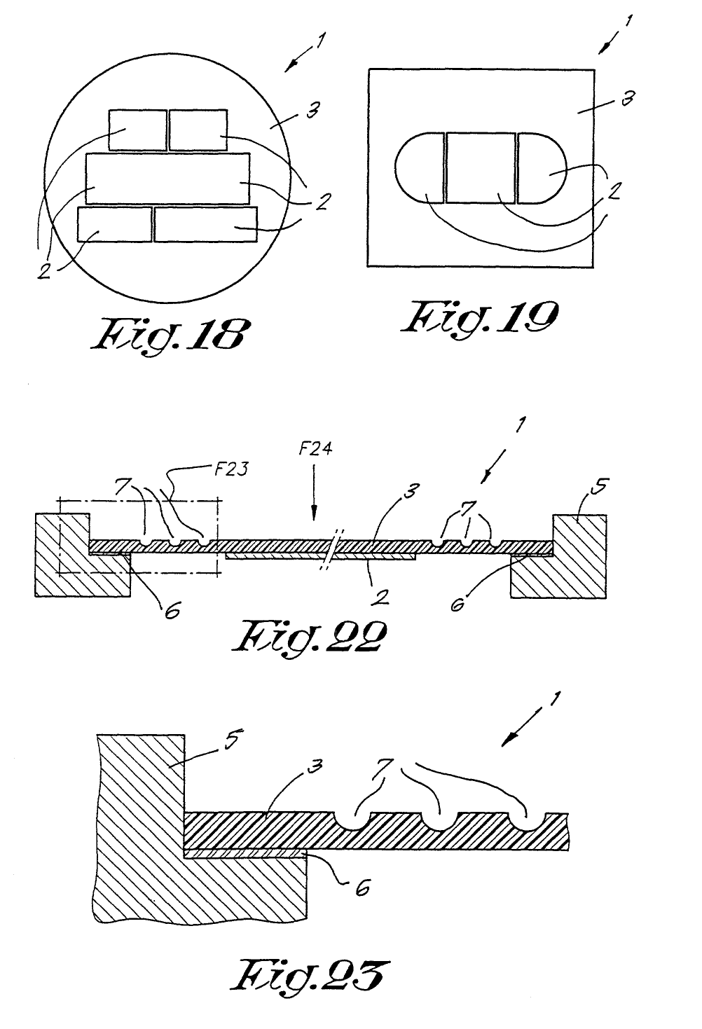

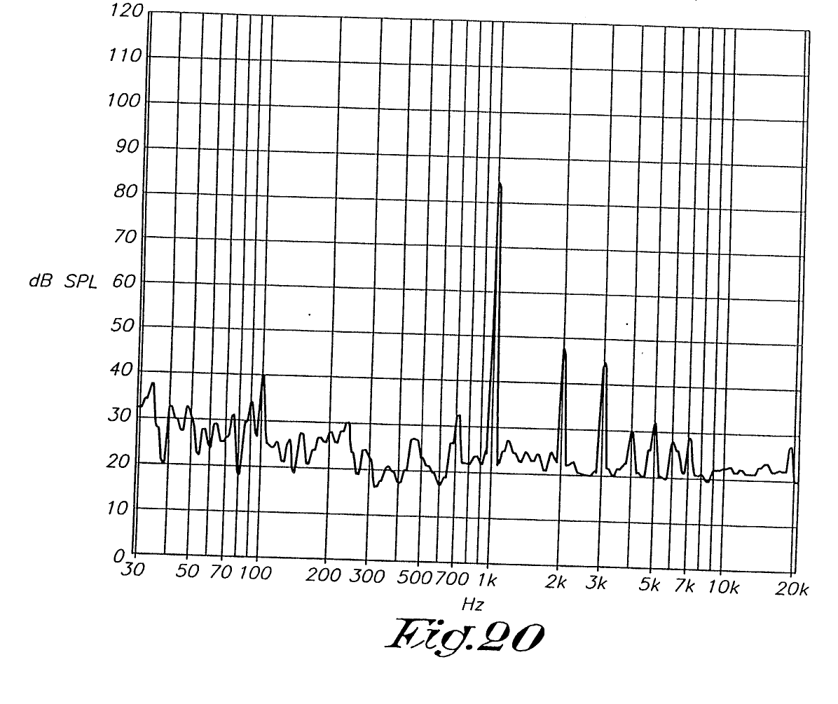

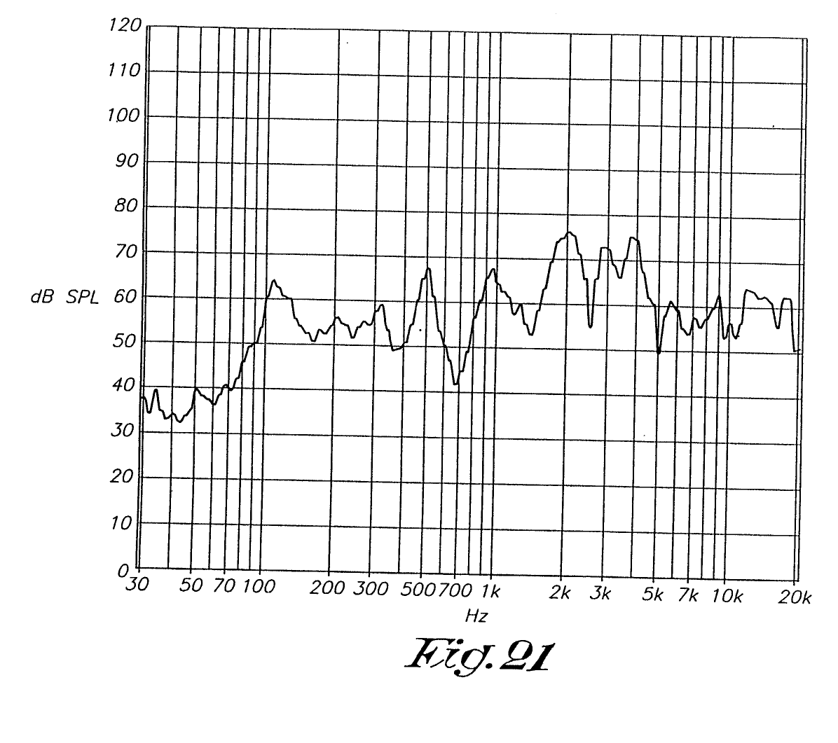

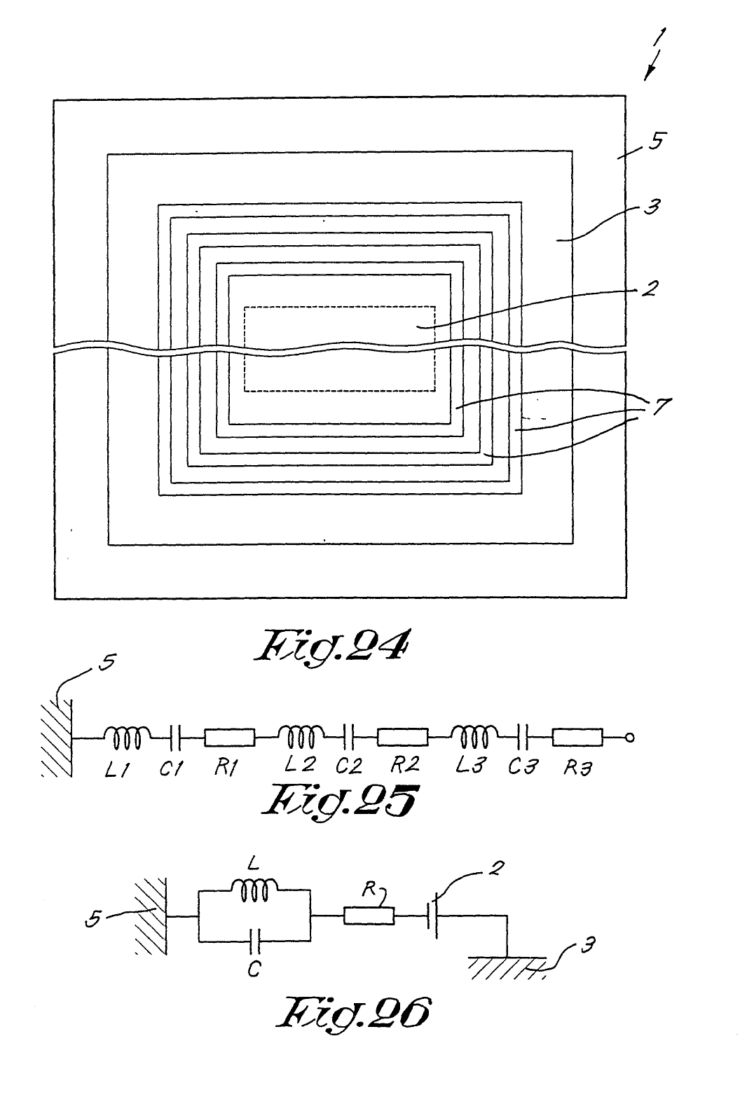

In FIG. 22, a transducer 1 according to the invention is represented which consists of a ceramic disk 2 and a membrane 3 of synthetic material, for example, a polymer, whereby this transducer 1 is fixed in a suspension frame 5 by means of a flexible glue 6.

The frame 5 may be made in a variety of materials, such as, for example, synthetic material, polymer, wood, composite materials and such, on the condition that they form an attenuating material.

In order to attenuate the vibration energy which would be created in the frame 5 due to transmission from the edge of the membrane 3 and, at the same time, to reduce the rigidity at the edge of the membrane, and thus allowing a more flexible movement due to the stretching and shrinking forces fo the ceramic disk 2, a number of grooves 7 are provided at the edge of the membrane 3 and over the entire circumference.

As a result, it is obtained:

that vibrations in the suspension frame 5 are attenuated,

that the amplitudinal deviation of the membrane 3 becomes larger,

and that, due to the attenuation effect in the longitudinal direction, specific and spontaneous resonances are prevented or strongly reduced.

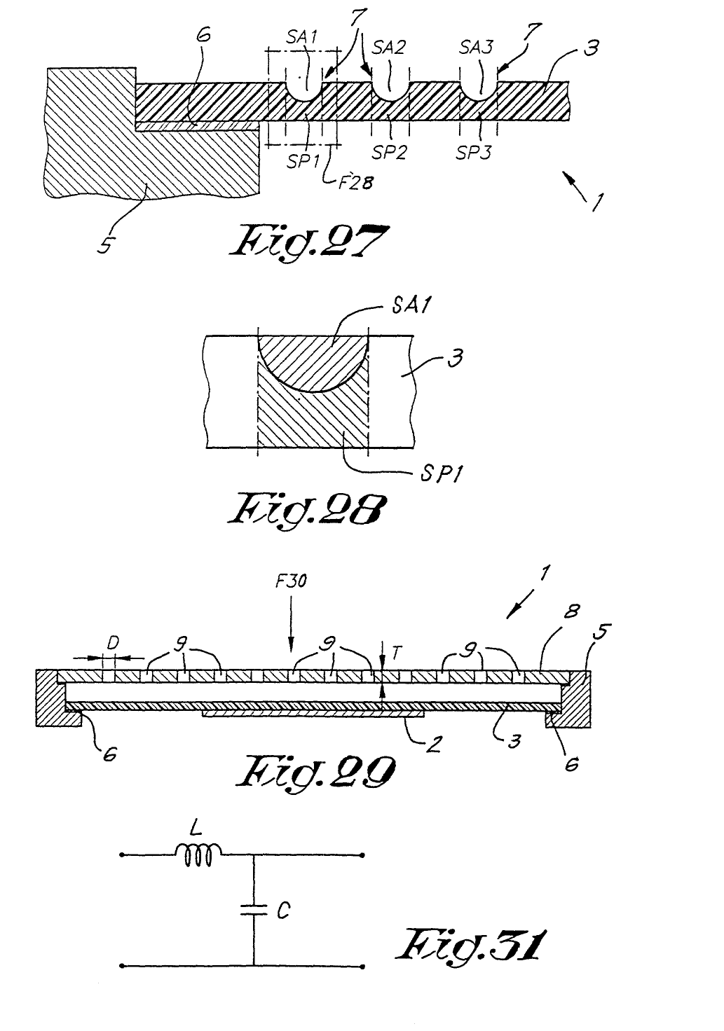

In FIGS. 25 and 26, the electric schemes of the grooves 7 at the circumference of a polymer membrane 3, glued in to a frame 5, are represented.

Hereby are:

R=losses and attenuation in membrane 3

R=R1+R2+R3

C=rigidity of the membrane 3

C=C1+C2+C3

L=mass of the membrane 3

L=L1+L2+L3

Furthermore are:

$$R = \frac{1}{SP1} + \frac{1}{SP2} + \frac{1}{SP3}$$

C=yP (SP1+SP2+SP3)

L=gP (SP1+SP2+SP3)

herein are:

gP=specific weight of the polymer

yP=elasticity modules E of Young of the membrane material of the polymer

SA=section of the air

SP=section of the membrane material

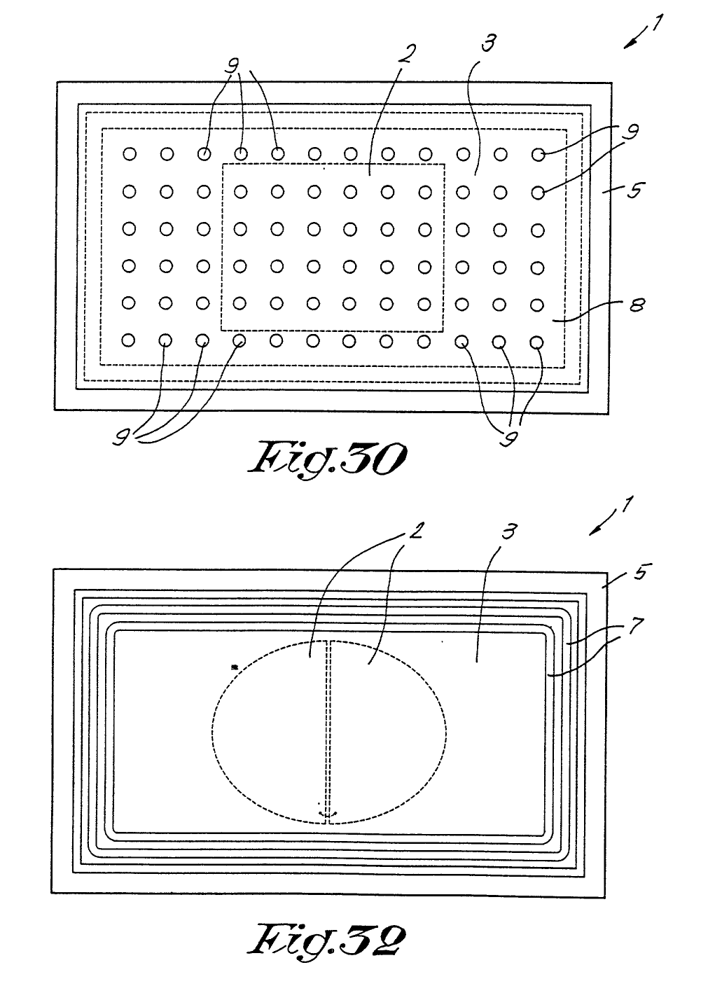

A transducer 1 according to the invention can be provided with a front plate 8, such as represented in FIG. 29, which plate shows a number of openings 9.

By using such front plate 8 with a thickness T and with a well-defined number of openings with diameter D, it is possible to realize a reactive acoustic filter which will refract a well-defined amount of energy.

Hereby, the surface of the openings 9 has a function as capacity per length unit, whereas the wall thickness T has a function as an inductance per length unit. See FIGS. 29 and 30.

Hereby, it is valid that (see FIG. 31)

L=fwLdx

$$C = \frac{1}{fwLdx}$$

L tot=nL2Πr

C tot=Πr²n

whereby

r=radius of an opening 9

n=number of openings 9.

The suspension frame 5 must have a strongly attenuating function.

If we take, for example, the case of a frame 5 made of precious wood, such as beech, of 2 cm wide and 3 cm thick, and a membrane 3 of polypropylene with grooves 7 at the circumference of the membrane 3, whereby at the front, a filter is provided in the shape of a front plate 8 with a thickness of 2 mm, in which a number of openings of 2 mm thickness are provided.

On the polypropylene membrane 3, two disks 2 are glued closely together and electrically connected to each other.

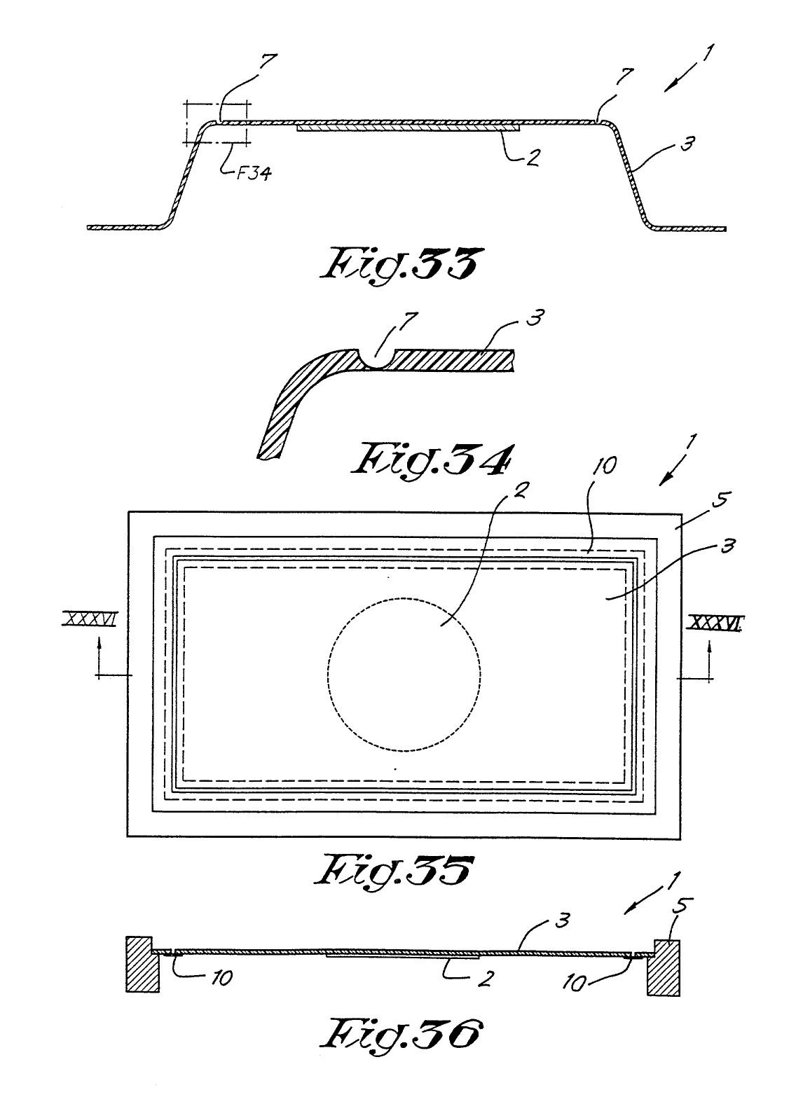

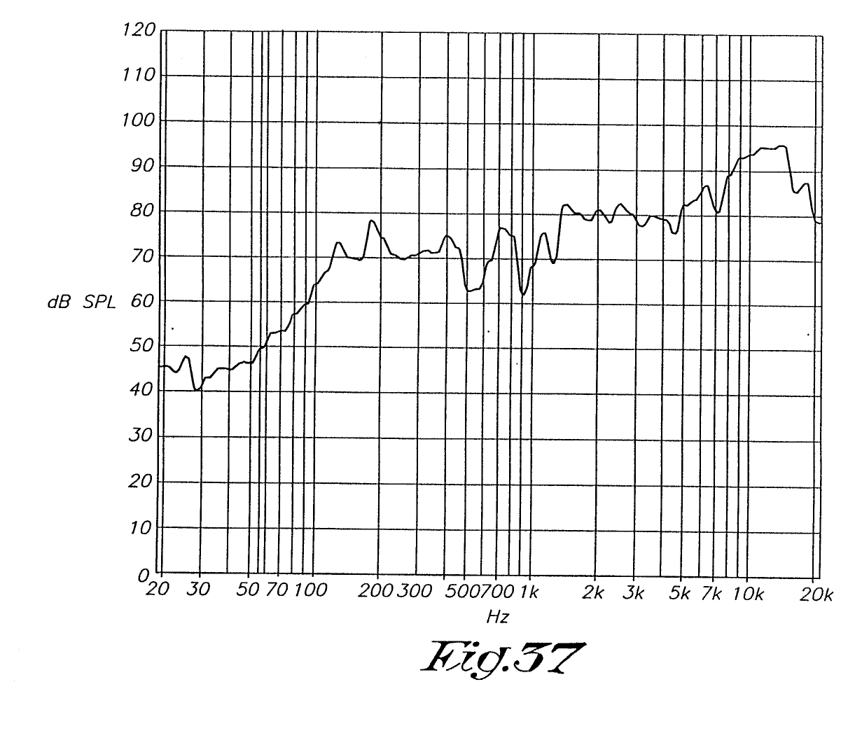

The construction of such reproduction element is represented in FIG. 32.

Hereby, the characteristics of the frequency analysis shows an overall harmonic distortion of 2% and a reproduction pressure of average 74 dB on a meter, see FIG. 20. The frequency reproduction is represented in FIG. 21.

In another construction, a round ceramic disk with a diameter of 5 cm is glued onto a rectangular membrane 3 of synthetic material, for example, polypropylene, the extremities of which are folded downward and the extremities are folded back and thus mounted onto a carrier surface (see FIG. 33).

At the extremity of the flat part of the polypropylene membrane, a groove 7 has been provided up to 90% of the thickness of the membrane 3.

An alternative is to provide said groove up to 100% in order to form an air slot and to glue the rectangular portion created thereby to the circumference by means of an adhesive tape 10, such as represented in FIGS. 35 and 36.

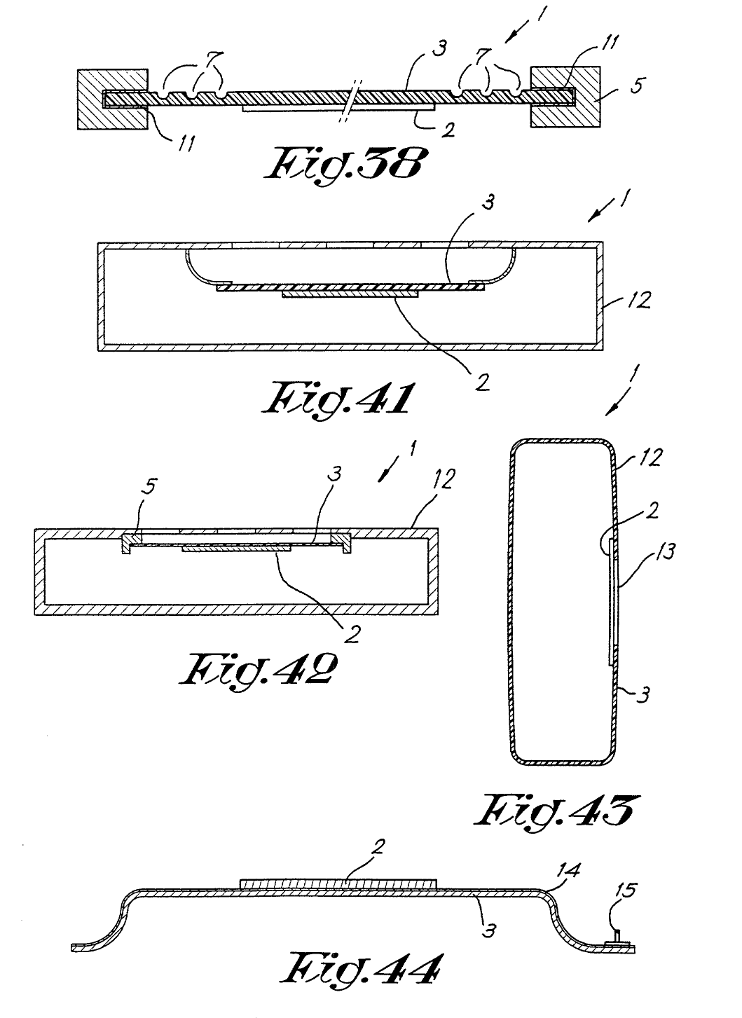

The frequency reproduction curve of this construction is represented in FIG. 37. Hereby, one will note that the refraction resonances from the edge suspension are almost entirely gone and that natural resonances of the membrane 3 and the ceramic 2 combination are not created, due to the functional difference of the circumference of the rectangle and the circle.

Still another example is represented in FIG. 38, whereby the circumference of the membrane 3 is framed, by the intermediary of silicone glue 11, in a frame 5 with a U-shaped diameter and realized in synthetic material.

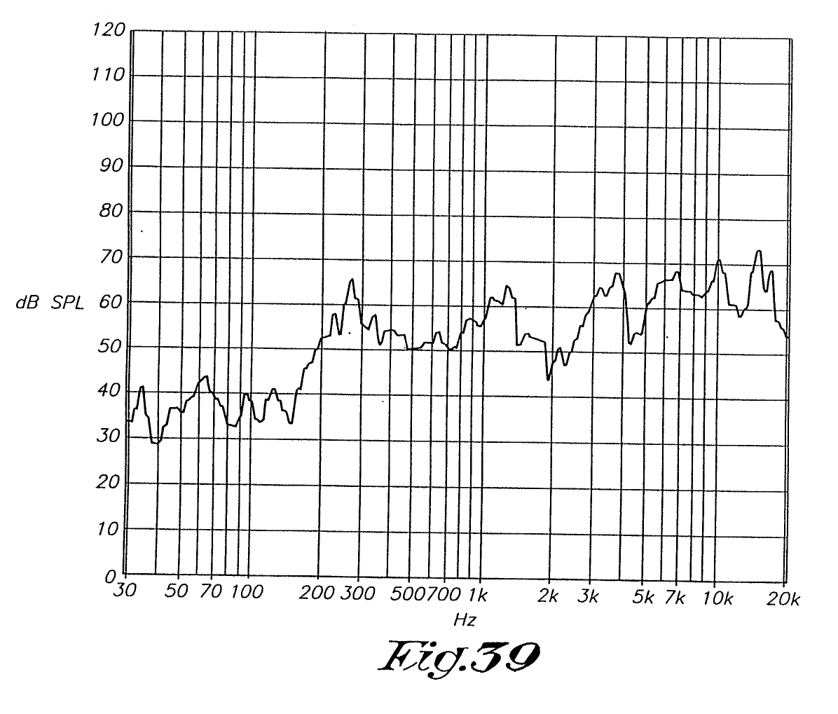

When the costs for industrial applications are important, the simplicity of the construction is primary and the frequency reproduction may vary up to +/−20 dB, then a circular membrane 3 made of polymer onto which a circular ceramic disk 2 is glued and at the edge is glued into a circular frame 5 with silicones 11 or another flexible glue, already is sufficient for realizing a very good music and speech reproduction. See the final results of the measurement of the frequency reproduction in FIG. 39, for a cylindrical and polymer membrane 3 with a diameter of 125 mm and a cylindrical ceramic disk 2 with a diameter of 100 mm.

The frequency distortion for this transducer is 3,5% for different frequencies, which is very acceptable for industrial purposes. See measurement FIG. 40.

In a certain embodiment, the transducer 1 according to the invention may be provided on an opened wall, in other words, a wall in which an opening is provided, whereby in that case the transducer is glued onto said wall by means of the membrane 3. Such application has a frequency reproduction of 50 Hz to 20 kHz, +/−5 Db, as represented in the measuring curve according to FIG. 40, whereby the membrane made of polypropylene has dimensions of 300×420 mm, the ceramic disk 2 has a diameter of 100 mm and the opening has a diameter of 260 mm.

Distortion measurements of this last-mentioned transducer, see FIG. 43, deliver a distortion of 1,5% intermodular distortion. Such transducer may have, for example, a thickness of maximum 5 mm and comprises, for example, two electric connections with a diameter of 0,5 mm.

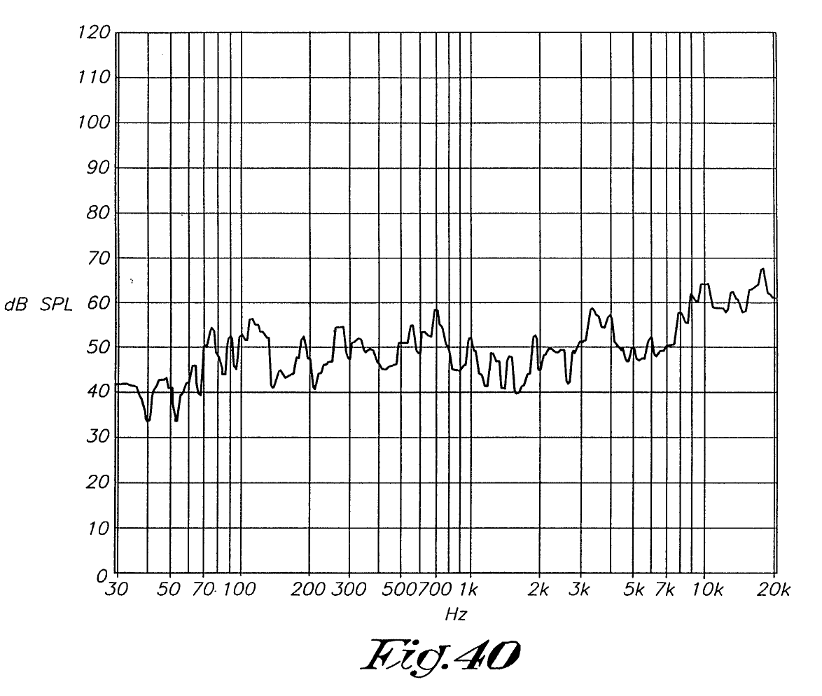

In FIGS. 41 and 42, examples are represented of such application in an existing housing 12.

In a very particular application, whereby the housing of a device is made of a synthetic material, for example, polycarbonate, the piezoceramic disk 2 can be attached directly at said housing, whereby in this case one will think specifically of the housing of a cellular phone, telephone or similar, such as schematically represented in FIG. 43. In this case, the housing, so to speak, forms the membrane 3 in which preferably an opening 13 is provided at the location of the ceramic disk 2.

In still another embodiment, see FIG. 44, the membrane 3 can be formed by a polymer film which either or not is coated with a layer of metal 14 on which a connection 15 is provided and which is deformed by means of thermic vacuum technology, after which the disk of piezoceramics 2 can be glued onto the metal side of the polymer film. This latter may consist of a mixture of polymeres, elastomeres or polyester.

The layer of metal 14 can, for example, be silver, gold, metal or another electric conductor which is brought into contact with one of the connections 15 of the transducer. As the ceramics is glued onto this metal layer and makes a contact, thereby a wireless contact with the ceramic is realized, and the membrane can move without being hampered by a local load.

It is obvious that the present invention is in no way limited to the examples described in the aforegoing and represented in the accompanying drawings; on the contrary, such transducer according to the invention may be realized in a variety of forms and dimensions, without leaving the scope of the invention.

1. A transducer, comprising a one-piece or multi-piece piezoceramic disk and a membrane formed of a material which attenuates sound vibrations.

2. The transducer according to claim 1, in which the membrane is formed of a soft material.

3. The transducer according to claim 1, in which the membrane is formed of synthetic material.

4. The transducer according to claim 1, in which the membrane comprises a polymer.

5. The transducer according to claim 1, in which the membrane comprises an elastomer.

6. The transducer according to claim 1, in which the membrane comprises a polypropylene.

7. The transducer according to claim 1, in which the membrane comprises a composite material.

8. The transducer according to claim 1, in which the piezoceramic disk is glued onto the membrane by means of a hard glue.

9. The transducer according to claim 1, in which a layer of metal is provided on the membrane.

10. The transducer according to claim 1, in which the membrane is provided with one or more circumferential grooves.

11. The transducer according to claim 10, in which the membrane has two sides opposite to each other and the ceramic disk is attached to one side while the groove or grooves are provided in the other side.

12. The transducer according to claim 10, in which the groove or grooves have a depth of 90% of the thickness of the membrane.

13. The transducer according to claim 10, in which the groove or grooves extend over the entire thickness of the membrane, and the thus formed membrane parts are mutually connected by means of adhesive tape or such.

14. The transducer according to claim 1, in which the membrane has a circumferential edge, the transducer being connected at the circumferential edge of the membrane to a frame, a housing of a device or similar by means of a flexible glue.

15. The transducer according to claim 1, which is formed by the housing of a device made of synthetic material, onto which the piezoceramic disk is attached.

16. The transducer according to claim 15, in which an opening is provided in the wall of the housing, at the location of the piezoceramic disk.

17. The transducer according to claim 13, including a suspension frame formed of a material which attenuates sound vibrations.

18. The transducer according to claim 17, in which the suspension frame has an L-shaped cross-section.

19. The transducer according to claim 18, in which the suspension frame has a U-shaped cross-section.

20. The transducer according to claim 1, wherein a frequency filter, formed by a plate with round openings therein, is provided in front of the transducer.
